(19) United States
(12) Patent Application Publication
(10) Pub. No.: US 2003/0084235 A1
(43) Pub. Date: May 1, 2003

(54) Synchronous DRAM controller and control method for the same

(76) Inventor: Yasutaka Mizuki, Kanagawa (JP)

Correspondence Address: Darryl G. Walker, WALKER & SAKO, LLP, Suite 235, 300 South First Street, San Jose, CA, 95113, US

(21) Appl. No.: 10/278,567

(22) Filed: Oct. 23, 2002

(30) Foreign Application Priority Data
Oct. 25, 2001 (JP) 2001-327957

(51) Int. Cl. G06F 12/00

(52) U.S. Cl. 711/105; 711/106; 713/320; 711/167

(57) ABSTRACT

A system (100) that may have a reduced power consumption during a standby state has been disclosed. A system (100) may include microprocessor unit (MPU) (101), a synchronous dynamic random access memory (SDRAM) controller (102), and a SDRAM (108). SDRAM controller (102) may include a power supply register (103) and a power supply control circuit (109). Power supply control register (103) may store an indicator as to whether or not data stored in SDRAM (102) is necessary. Power supply control circuit (109) may maintain or turn off a power supply to SDRAM (103) when system (100) enters a standby state in accordance with a value stored in power supply control register (103). In this way, current consumption in a standby state may be reduced and a time delay when a system (100) returns to a normal state may be reduced.

### TECHNICAL FIELD

The present invention relates generally to a synchronous DRAM controller and more particularly to a synchronous DRAM controller which may designate an operation at a time of a transition from a low power consumption mode (standby) to reduce power consumption in a Synchronous DRAM and a control method for the same.

### BACKGROUND OF THE INVENTION

The advancement of semiconductor device fabrication techniques has enabled the manufacturing of high-speed high-integration semiconductor storage devices. These semiconductor storage devices have contributed to improvements in the speed and functional operation of information processors, personal computers, communication devices, and portable information devices, and the like.

Ordinarily, a microprocessor unit (MPU) for controlling an entire system in the above-mentioned devices and a synchronous dynamic random access memory (SDRAM) can be used as a storage device. In this case, the SDRAM is placed in a standby state when the MPU is in a standby state.

When the system is in a standby state, the need to save data stored in the SDRAM may depend on the specific use of the system or an application program used in the system. The method of controlling the SRAM can be selected according to whether or not saving of data stored in the SDRAM is required.

One control technique that can be used when a system requires data in the SDRAM to be saved when the system is in a standby state includes a technique for setting the SDRAM in a self-refresh state. Referring now to FIG. 8, a block schematic diagram illustrating a conventional system is set forth and given the general reference character 800. Conventional system 800 includes a technique for setting the SDRAM in a self-refresh state.

Conventional system 800 includes a MPU 101, an SDRAM controller 802, and an SDRAM 108 as well as other peripheral circuits (not illustrated in FIG. 8). Conventional system 800 can be used in one of the above-mentioned devices (e.g., a portable information device) to perform necessary processing.

SDRAM controller 802 controls access of data and refresh operations for SDRAM 108. SDRAM controller 802 includes a control circuit 804, a self-refresh circuit 105, and an auto-refresh circuit 106.

MPU 101 performs overall control of system 800. When a read operation of data stored in SDRAM 108 or write operation of data to SDRAM 108 is performed, MPU 101 outputs a request accordingly to SDRAM controller 802.

Control circuit 804 in SDRAM controller 802 recognizes the request from MPU 101 and accesses SDRAM 108. SDRAM controller 802 operates in the same manner for other requests to perform direct control of SDRAM 108.

Control circuit 804 is a circuit for controlling the operation of each circuit in SDRAM controller 802 necessary for control of SDRAM 108. Self-refresh circuit 105 is a circuit for setting SDRAM 108 in a self-refresh mode to enable SDRAM 108 to perform a self-refresh operation. Auto-refresh circuit 106 is a circuit for refreshing SDRAM 108 when SDRAM 108 is in a normal state.

Generally speaking, data stored in volatile memories (such as an SDRAM) can be indeterminate immediately after turning on a power supply. Thus, there is a need to initialize the data in the SDRAM immediately after turning on the power supply.

Referring now to FIG. 9, a flowchart showing operations for changing conventional system 800 from a normal state to a standby state and from the standby state to a normal state is set forth.

In a step S91, SDRAM controller 802 sets SDRAM 108 in the self-refresh mode in accordance with instructions from MPU 101. When SDRAM 108 is set in the self-refresh mode, SDRAM 108 performs a minimal refresh operation using an internal refresh circuit to save data stored therein even if no instruction is provided from SDRAM controller 802. In a step S92, MPU 101 is set into a self-imposed standby state. After execution of step S92, conventional system 800 enters a standby state to reduce power consumption.

In a step S93, conventional system 800 awaits an occurrence to cause an exit from the standby state. In the standby state, power consumption is reduced because conventional system 800 has substantially no activity. When an occurrence occurs (e.g. a key input or an external interrupt), conventional system 800 transitions over to a normal state.

In a step S94, MPU 101 exits from the standby state.

In a step S95, SDRAM controller 802 sets the SDRAM 108 in an auto-refresh mode in accordance with instructions from MPU 101. After setting SDRAM 108 in the auto-refresh mode, SDRAM controller 802 executes a refresh operation at regular intervals. With the completion of this step, conventional system 800 completes a transition to a normal state.

The state transition (changeover) illustrated in FIG. 9 will now be described with the timing diagram of FIG. 10.

Referring now to FIG. 10, a timing diagram illustrating transitions between a normal operation and a standby state of a conventional system is set forth. The timing diagram of FIG. 10 includes a SDRAM operation clock CLK, a clock enable CKE, a state of SDRAM 108, a state of MPU 101, and SDRAM dissipation current.

When a decision to transition from a normal state to a standby state has been made by conventional system 800, MPU 101 sets SDRAM 108 in a self-refresh mode at time TS91. At this time, self-refresh circuit 105 starts operating while auto-refresh circuit 106 stops operating. Clock enable signal CKE transitions to a low level to prevent SDRAM operation clock CLK from operating (prevents oscillation).

Through the above-mentioned steps, SDRAM 108 transitions to a self-refresh mode. Then, at time TS92, MPU 101 changes its own state to a standby state to set the entire conventional system 800 in a standby state (during the period illustrated at time TS93).

If an event, such as a key input for example, occurs to cause an exit from the standby state at this time, MPU 101 exits from the standby state by transitioning (changing over) to a normal state.

Subsequently, at time TS95, SDRAM 108 is set in an auto-refresh mode. Auto-refresh circuit 106 then starts operating (controlling refresh), clock enable signal CKE transitions to a high level to enable SDRAM operation clock CLK. Thus, SDRAM operation clock CLK operates (oscillates) and SDRAM 108 transitions (switches over) to a normal state. In this way, the entire conventional system 800 is set in a normal state by the above-described operations.

On the other hand, a technique for further reducing power consumption is disclosed in JP 7-061059. In this case, data stored in a SDRAM is required to be saved when a standby state is entered.

Referring now to FIG. 11, a block schematic diagram of a conventional controller unit in a printing apparatus is set forth and given the general reference character 1000. Conventional controller unit 1000 includes a microprocessor 1001, a ROM 1002, a DRAM 1003, a nonvolatile memory 1004, and interface circuits (1006 and 1007). Conventional controller unit 1000 for a printing apparatus copies data stored in DRAM 1003 to a nonvolatile memory 1004 before transitioning to a standby state. After the completion of the transition to a standby state, Conventional controller unit 1000 turns off the power supply voltage to DRAM 1003.

In this way, conventional controller unit 1000 can reduce the amount of power required for self-refresh by SDRAM 1003. When conventional controller unit 1000 transitions from the standby state to a normal state, a process for writing data back to DRAM 1003 from nonvolatile memory 1004 is performed. After the completion of the writing back process, conventional controller unit 1000 has transitioned to the normal state.

In the above-described conventional system, the technique relates to a case where data stored in a DRAM is required at the time of transitions between a standby state and a normal state. The above-described techniques may still use power unnecessarily when data stored in a DRAM is not necessary at the time of transitions between a standby state and a normal state.

Portable information devices (for example portable telephones or the like) operate using battery power. In such devices, it is desirable to reduce power consumption.

When data stored in a DRAM is copied to a nonvolatile memory during a transition to a standby state as disclosed in JP 7-061059 A, a certain time period is required for this transfer. Additionally a time period is required for the write back operation for a transition back to a normal state. This can reduce the overall processing speed of the system.

Also, a voltage of about 12 V can be required to write data to a nonvolatile memory. To provide the 12 V, it is typically necessary to provide a separate external power supply to supply the increased voltage or provide an internal boosting circuit. However, it is difficult to provide a separate power supply for a battery driven portable device. When an internal boosting circuit is provided, a circuit having a relatively high power consumption, such as a ring oscillator and/or a charge pump, is used. This can increase power consumption and reduce battery charge life.

In view of the above discussion, it would be desirable to provide a DRAM (SDRAM) controller which may allow a system to select saving or not saving of data stored in a DRAM (SDRAM) when an MPU enters a standby state. It would also be desirable to provide DRAM (SDRAM) controller that may allow a power supply to the DRAM (SDRAM) to be turned off in a standby state if data stored in the DRAM (SDRAM) is not necessary.

### SUMMARY OF THE INVENTION

According to the present embodiments, a system that may have a reduced power consumption during a standby state is disclosed. A system may include a microprocessor unit (MPU), a synchronous dynamic random access memory (SDRAM) controller, and a SDRAM. A SDRAM controller may include a power supply register and a power supply control circuit. A power supply control register may store an indicator as to whether or not data stored in a SDRAM is necessary. A power supply control circuit may maintain or turn off a power supply to a SDRAM when a system enters a standby state in accordance with a value stored in a power supply control register. In this way, current consumption in a standby state may be reduced and a time delay when a system returns to a normal state may be reduced.

According to one aspect of the embodiments, a SDRAM controller which may control operations of a SDRAM including reading and writing according to instructions received from a MPU may include a power supply designation circuit, a control circuit, and a power supply control circuit. A power supply designation circuit may designate maintaining or turning off a power supply provided to the SDRAM when the SDRAM is in a low power consumption state in accordance with whether data stored in the SDRAM is necessary or unnecessary. A control circuit may control the operation of circuits included in the SDRAM controller according to instructions received from the MPU. A power supply control circuit may control turning off/maintaining the power supply in accordance with a power supply logic signal provided by the power supply designation circuit.

According to another aspect of the embodiments, the power supply control circuit may turn off the power supply to the SDRAM in response to the power supply logic signal being a power supply turn off logic level and an instruction from the MPU to effect a transition to the lower power supply consumption state. The power supply control circuit may turn on the power supply to the SDRAM in response to an instruction from the MPU to effect a transition to a normal state.

According to another aspect of the embodiments, the power supply designation circuit may include a latch circuit. The latch circuit may have a power supply status indicator loaded into in response to a write signal.

According to another aspect of the embodiments, the power supply status designation circuit may include a power supply status designation terminal that may receive the power supply logic signal which may be provided external to the SDRAM controller.

According to another aspect of the embodiments, the power supply control circuit may turn off the power supply to the SDRAM when the SDRAM is in a self-refresh mode and the data stored in the SDRAM is unnecessary.

According to another aspect of the embodiments, the power supply designation circuit may receive an address from an address bus and a data signal from a data bus and may store the data signal as the power supply logic signal in response to a write signal when the register address has a predetermined address value.

According to another aspect of the embodiments, the control circuit may include an address generation circuit, a command generation circuit, and a control register. The address generation circuit may receive an address and may determine whether the address is for the SDRAM or for the SDRAM controller. The command generation circuit may receive instructions from the MPU and may provide control signals controlling the operation of at least one circuit in the control circuit. The control register may receive data from a data bus and may set an operation of the SDRAM controller.

According to another aspect of the embodiments, the control circuit may include a data latch and a latch circuit. The data latch may be connected between the MPU and the SDRAM and may provide a handshake for data timing between the MPU and the SDRAM. The latch circuit may receive a row address and a column address from the address generation circuit and may provide a handshake for address timing to SDRAM from the MPU.

According to another aspect of the embodiments, the command generation circuit may include a timer for setting timing and a decoder and sequencer for executing instructions.

According to another aspect of the embodiments, a method of controlling a first synchronous dynamic random access memory (SDRAM) with a SDRAM controller in a system may include the steps of receiving a request to transition the system from a normal state to a standby state, determining whether a first power supply provided to the first SDRAM is to be turned off or kept on in accordance with whether data stored in the first SDRAM is necessary or unnecessary, and turning off the first power supply provided to the first SDRAM if the step of determining determines that the data stored in the first SDRAM is unnecessary.

According to another aspect of the embodiments, the method may include the step of providing a first power supply status indication to the SDRAM controller after determining whether the first power supply provided to the first SDRAM is to be turned on or kept off.

According to another aspect of the embodiments, the method may include the step of setting the first SDRAM in a low power consumption state before the step of turning off the first power supply.

According to another aspect of the embodiments, the method may include the steps of receiving a request to transition the system from the standby state to the normal state and turning on the first power supply provided to the first SDRAM if the step of determining determined that the data stored in the first SDRAM was unnecessary.

According to another aspect of the embodiments, the method may include the step of initializing the first SDRAM after the step of turning on the first power supply.

According to another aspect of the embodiments, the system may further include a second SDRAM and the method may include the steps of determining whether a second power supply provided to the second SDRAM is to be turned off or kept on in accordance with whether data stored in the second SDRAM is necessary or unnecessary, and turning off the second power supply provided to the second SDRAM if the step of determining determines that the data stored in the second SDRAM is unnecessary.

According to another aspect of the embodiments, the method may include the step of providing a second power supply status indication to the SDRAM controller after determining whether the second power supply provided to the second SDRAM is to be turned on or kept off.

According to another aspect of the embodiments, the method may include the step of setting the second SDRAM in a low power consumption state before the step of turning off the second power supply.

According to another aspect of the embodiments, the method may include the steps of receiving a request to transition the system from the standby state to the normal state and turning on the second power supply provided to the second SDRAM if the step of determining determined the data stored in the second SDRAM was unnecessary.

According to another aspect of the embodiments, the method may include the step of initializing the second SDRAM after the step of turning on the second power supply.

According to another aspect of the embodiments, the method may include the step of setting the first SDRAM in a self-refresh mode before the step of turning off the first power supply.

### BRIEF DESCRIPTION OF THE DRAWINGS

FIG. 1 is a block schematic diagram of a system including a SDRAM controller according to an embodiment.

FIG. 2 is a flowchart showing operations for changing a system from a normal state to a standby state and from the standby state to a normal state according to an embodiment.

FIG. 3A is a timing diagram showing transitions between a normal state and a standby state when data stored in a SDRAM is not necessary according to an embodiment.

FIG. 3B is a timing diagram showing transitions between a normal state and a standby state when data stored in a SDRAM is necessary according to an embodiment.

FIG. 4 is a block schematic diagram of a system including a SDRAM controller according to an embodiment.

FIG. 5 is a flowchart showing operations for changing a system from a normal state to a standby state and from the standby state to a normal state according to an embodiment.

FIG. 6 is a timing diagram showing transitions of a system between a normal state and a standby state according to an embodiment.

FIG. 7 is a block schematic diagram of a system including a SDRAM controller according to an embodiment.

FIG. 8 is a block schematic diagram of a conventional system.

FIG. 9 is a flowchart showing operations for changing a conventional system from a normal state to a standby state and from the standby state to a normal state

FIG. 10 is a timing diagram illustrating transitions between a normal operation and a standby state of a conventional system.

FIG. 11 is a block schematic diagram of a conventional controller unit in a printing apparatus.

FIG. 12A is a circuit schematic diagram of a power supply control register according to an embodiment.

FIG. 12B is a timing diagram illustrating a write timing for writing a logic level to a power supply control register according to an embodiment.

FIG. 13 is a circuit schematic diagram of a control circuit according to an embodiment.

### DETAILED DESCRIPTION OF THE EMBODIMENTS

Various embodiments of the present invention will now be described in detail with reference to a number of drawings.

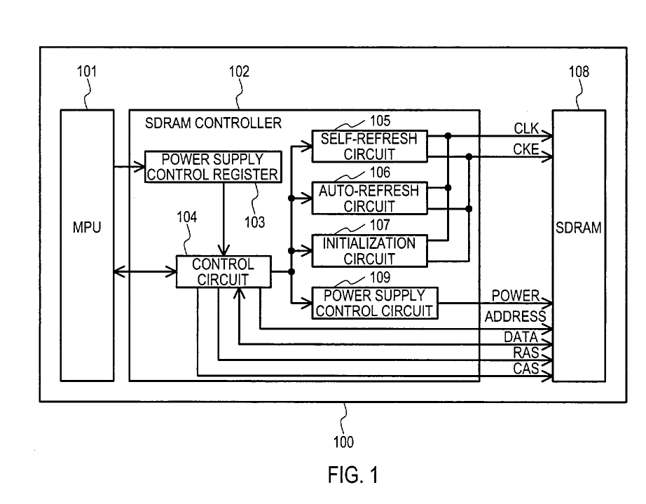

Referring now to FIG. 1, a system including a SDRAM controller according to an embodiment is set forth and given the general reference character 100.

System 100 may include a microprocessor unit (MPU) 101, a SDRAM (synchronous dynamic random access memory) controller 102, a SDRAM 108, and other peripheral circuits (not shown in FIG. 1). System 100 may be included in a portable information device, or the like, to perform processing.

SDRAM controller 102 may control access (reading or writing) of data, or the like, and refresh operations in SDRAM 108. SDRAM controller 102 may receive requests from MPU 101 and may provide a clock signal CLK, a clock enable signal CKE, a power supply POWER, an address ADDRESS, a row address signal RAS, and a column address signal RAS to SDRAM 108. Other control signals (not shown) may also be provided to SDRAM 108 from SDRAM controller 102. SDRAM controller 102 may also receive or provide data DATA from/to SDRAM 108.

In the arrangement of FIG. 1, MPU 101 may perform overall control of system 100. When data stored in SDRAM 108 is to be read or when data is to be written to SDRAM 108, MPU 101 may provide a request to SDRAM controller 102. SDRAM controller 102 may recognize the request from MPU 101 and may access the SDRAM 108 accordingly. SDRAM controller 102 may operate in a similar manner to other requests to perform direct control of SDRAM 108.

SDRAM controller 102 may include a power supply control register 103, a control circuit 104, a self-refresh circuit 105, an auto-refresh circuit 106, an initialization circuit 107, and a power supply control circuit 109. Power supply control register 103 may receive a power supply setting request from MPU 101 and provide a power supply control register state to a control circuit 104. Control circuit 104 may receive a request from MPU 101 and may provide control signals to self-refresh circuit 105, auto-refresh circuit 106, initialization circuit 107, and power supply control circuit 109. Control circuit 104 may also provide row address strobe signal RAS and column address strobe signal CAS to SDRAM 108 and may provide or receive data DATA to or from SDRAM 108. Self-refresh circuit 105, auto-refresh circuit 106, and initialization circuit 107 may provide a clock signal CLK and a clock enable signal CKE to SDRAM 108.

Power supply control register 103 may hold an instruction to turn off a power supply POWER to SDRAM 108 when SDRAM 108 is put in a self-refresh mode. Power supply control register 103 may have such a setting that a power supply POWER to SDRAM 108 may be turned off when a high logic level is stored, and power supply POWER to SDRAM 108 may not be turned off when a low logic level is stored.

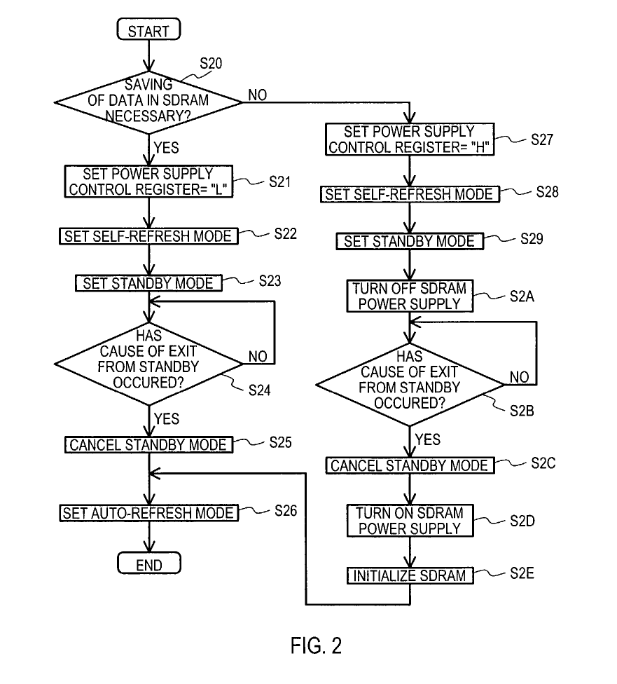

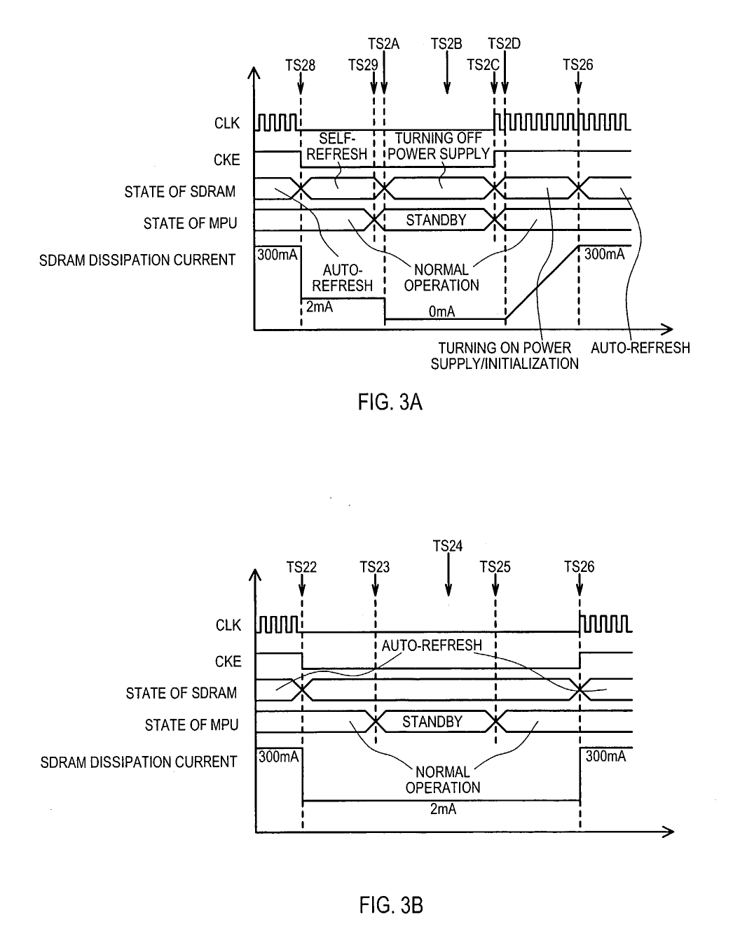

The operation of SDRAM controller 102 when system 100 transitions from a normal state to a standby state and transitions from a standby state to a normal state will now be described with reference to a flowchart of FIG. 2 and timing diagrams of FIGS. 3A and 3B in conjunction with FIG. 1.

FIG. 2 is a flowchart showing operations for changing system 100 from a normal state to a standby state and from the standby state to a normal state according to an embodiment. FIG. 3A is a timing diagram showing transitions between a normal state and a standby state when data stored in a SDRAM is not necessary according to an embodiment. FIG. 3B is a timing diagram showing transitions between a normal state and a standby state when data stored in a SDRAM is necessary according to an embodiment.

Referring now to FIGS. 2 and 3 in conjunction with FIG. 1, first, a request for transitioning of system 100 from a normal state to a standby state may be made.

If a determination in step S20 of FIG. 2 determines that data stored in SDRAM 108 is not necessary, MPU 101 may direct SDRAM controller 102 to store a high level in power supply control register 103 as indicated in step S27.

Subsequently, at time TS28 (FIG. 3A), MPU 101 may issue a request to put SDRAM 108 into a self-refresh mode. In response to this request, SDRAM controller 102 may set clock enable signal CKE to a low level and disable clock signal CLK (stop oscillations). In this way, SDRAM 108 may transition to a self-refresh mode (step S28).

At time TS29 (FIG. 3A), MPU 101 may transition to a standby state and system 100 may enter a standby state (step S29). At time TS2A (FIG. 2A), after SDRAM 108 has entered a self-refresh state, power supply control circuit 109 may turn off power supply to SDRAM 108 (step S2A). In this way, system 100 may transition to a standby state and overall power consumption may be reduced.

System 100 may be maintained in a standby state (step S2B (FIG. 2) and time TS2B (FIG. 3A)) until an event, such as a key input, an external interrupt, or the like, occurs to cause an exit from the standby state.

When an event occurs to cause an exit from the standby state (time TS2C of FIG. 3A), MPU 101 may transition from a standby state to a normal state (step S2C of FIG. 2) and may first provide a request to SDRAM controller 102 to turn on power supply POWER of SDRAM 108 (setting power supply control register 103 to store a logic low level).

SDRAM controller 102 may receive the request from MPU 101, and power supply control circuit 109 may initiate turning on of power supply POWER (time TS2D in FIG. 3A and step S2D of FIG. 2). After power supply POWER has been turned on sufficient to allow operation of SDRAM 108, SDRAM controller 102 may set clock enable signal CKE to a high level to enable the operation of clock signal CLK (clock signal CLK may begin to oscillate). Subsequently, SDRAM controller 102 may activate initialization circuit 107 to initialize SDRAM 108 (step S2E of FIG. 2).

After the completion of initialization, SDRAM controller 102 may activate auto-refresh circuit 106 to change over SDRAM 108 to a normal state (step S26 of FIG. 2). In this way, system 100 may complete a transition to a normal state.

Next, if data stored in SDRAM 108 has been determined to be necessary (step S20 of FIG. 2), MPU 101 may direct SRAM controller 102 to store a low level in power supply control register 103 as indicated in step S21.

Subsequently, at time TS22 (FIG. 3B), MPU 101 may issue a request to put SDRAM 108 into a self-refresh mode. In response to this request, SDRAM controller 102 may set clock enable signal CKE to a low level and disable clock signal CLK (stop oscillations). In this way, SDRAM 108 may transition to a self-refresh mode (step S22 of FIG. 2).

At time TS23 (FIG. 3B), MPU 101 may transition to a standby state and system 100 may enter a standby state (step S23). System 100 may transition to a standby state therewith, while data stored in SDRAM 108 may be saved.

System 100 may be maintained in a standby state (step S24 (FIG. 2) and time TS24 (FIG. 3B)) until an event, such as a key input, an external interrupt, or the like, occurs to cause an exit from the standby state.

When an event occurs to cause an exit from the standby state (time TS25 of FIG. 3B), MPU 101 may transition from a standby state to a normal state (step S25 of FIG. 2). At time TS26 (FIG. 3B), SDRAM controller 102 may activate auto refresh circuit 106 and may set clock enable signal CKE to a high level to enable the operation of clock signal CLK (clock signal CLK may begin to oscillate). In this way, SDRAM 108 may transition to a normal state (step S26 of FIG. 2) and system 100 may complete a transition to a normal state therewith.

In the embodiment of FIG. 1, the above-described power supply control circuit 109 may be provided in SDRAM controller 102. However, in some cases it may be preferable to provide power supply control circuit 109 outside SDRAM controller 102 because a power supply control circuit may relate directly to a power supply designated to a SDRAM 108.

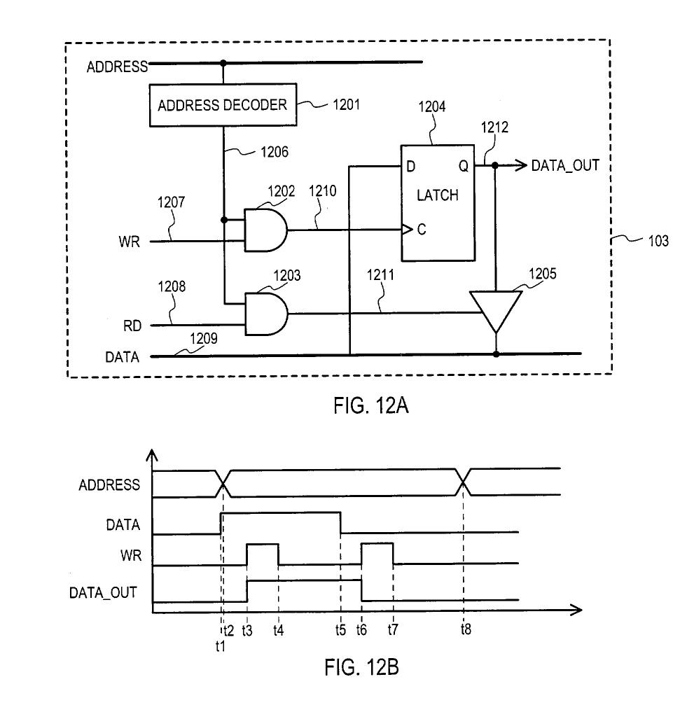

Power supply control register 103 will now be described with reference to FIGS. 12A and 12B.

FIG. 12A is a circuit schematic diagram of power supply control register 103 according to an embodiment. FIG. 12B is a timing diagram illustrating a write timing for writing a logic level to power supply control register 103 according to an embodiment.

Power supply control register 103 may include an address decoder 1201, AND gates (1202 and 1203), a latch circuit 1204, and a buffer circuit 1205. Address decoder 1201 may receive an address ADDRESS as an input and may provide a power supply control enable signal 1206 as an output. AND gate 1201 may receive power supply control enable signal 1206 as one input and a write signal 1207 as another input and may provide a write latch signal 1210 as an output. AND gate 1203 may receive power supply control enable signal 1206 as one input and a read signal 1208 as another input and may provide a read latch signal 1211 as an output. Latch circuit 1204 may receive a data bit from data bus 1209 at a data input D and write latch signal 1210 at a clock input C and may provide a latched data out DATA_OUT at an output Q. Buffer 1205 may receive latched data out DATA_OUT at an input and read latch signal 1211 at a control terminal and may provide an output to a data line on data bus 1209.

MPU 101 may write data (l-bit) to power supply control register 103 or may read data stored in power supply control register 103 by providing an address ADDRESS and a write signal WR or a read signal RD. Address decoder 1201 may receive address ADDRESS and may provide power supply control enable signal 1206 having a high logic level if the received address ADDRESS matches a predetermined value and a low logic level if the received address ADDRESS does not match the predetermined value. Accordingly, when power supply control enable signal 1206 has a high logic level, AND gates (1202 and 1203) may be enabled and MPU 101 may read or write data stored in power supply control register 103 accordingly.

Referring now to FIG. 12A in conjunction with FIG. 12B, a description of MPU 101 controlling a write of latched data to power supply control register 103 will be given.

At time t1, MPU 101 may provide data DATA to power supply control register 103 having a predetermined value in accordance with whether or not power supply POWER is to be turned off or turned on. In this case, data DATA has a logic high value. At time t2, MPU 101 may provide an address ADDRESS to power supply control register 103 having a predetermined value. Address decoder 1201 may receive address ADDRESS and provide power supply control enable signal 1206 having a high logic level. In this way, AND gates (1202 and 1203) may be enabled. At time t3, MPU 101 may provide write signal WR having a logic high level. In response to write signal WR having a logic high level, AND gate 1202 may provide a write latch signal 1210 having a logic high level to clock input C of latch circuit 1204. In this way, latch circuit 1204 may be loaded with data DATA (logic high in this case) and latched data out DATA_OUT may become logic high. A logic high loaded in latch circuit 1204 may indicate power supply POWER (FIG. 1) is to be turned off. At time t4, write signal WR may return to a logic low value.

At time t5, MPU 101 may provide a data DATA having a logic low value to power supply control register 103. At time t6, MPU 101 may provide write signal WR having a logic high level. In response to write signal WR having a logic high level, AND gate 1202 may provide a write latch signal 1210 having a logic high level to clock input C of latch circuit 1204. In this way, latch circuit 1204 may be loaded with data DATA (logic low in this case) and latched data out DATA_OUT may become logic low. A logic low loaded in latch circuit 1204 may indicate power supply POWER (FIG. 1) is to be turned on. At time t7, write signal WR may return to a logic low level.

At time t8, MPU 101 may provide an address ADDRESS to power supply control register 103 not having a predetermined value. Thus, address decoder 1206 may provide power supply control enable signal 1206 having a low logic level. In this way, power supply control register 103 may be disabled.

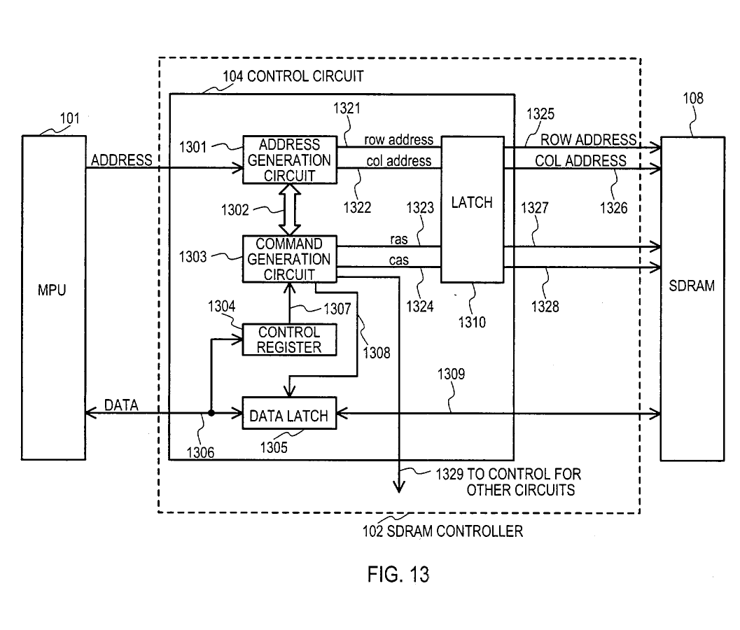

Control circuit 104 in SDRAM controller 102 will now be described with reference to FIG. 13.

FIG. 13 is a circuit schematic diagram of control circuit 104 according to an embodiment.

Control circuit 104 may include an address generation circuit 1301, a command generation circuit 1303, a control register 1304, a data latch 1305, and a latch circuit 1310.

Address generation circuit 1301 may receive an address ADDRESS from MPU 101 and may receive and/or provide control signals on a bus 1302. Address generation circuit 1301 may provide a row address 1321 and a column address 1322. Command generation circuit 1303 may receive data 1307 stored in a control register 1304 and may provide and/or receive control signals on bus 1302. Command generation circuit 1303 may provide a row address strobe signal 1323, a column address strobe signal 1324, and an enable signal 1308. Control register 1304 may receive data DATA and may provide stored data 1307 as an output. Data latch 1305 may receive/provide data DATA from/to MPU 101 and enable signal 1308 and may receive/provide data 1309 to/from SDRAM 108. Latch circuit 1310 may receive row address 1321, column address 1322, row address strobe 1323, and column address strobe 1324 and may provide a latched row address 1325, column address 1326, row address strobe 1327, and column address strobe 1328. SDRAM 108 may receive latched row address 1325, column address 1326, row address strobe 1327, and column address strobe 1328.

Address generation circuit 1301 in control circuit 104 may function as an address decoder and may distinguish an address value receive for SDRAM 108 and an address value received for SDRAM controller 102 from each other.

Control register 1304 in control circuit 104 may be a group of registers for setting an operation of SDRAM controller 102. Data read/write thereon may be performed through each of address and data buses.

Data latch 1305 and latch circuit 1310 may provide a buffer for temporarily holding data or a signal at a time of a write to or a read from SDRAM 108. In this way, a handshake for timing between MPU 101 and SDRAM 108 may be performed.

Command generation circuit 1303 may provide a control function for control circuit 104. Command generation circuit 1303 may interpret instructions from MPU 101 and may control operations of control circuit 104. Command generation circuit 1303 may incorporate, for example, a timer for setting timing, and a decoder and sequencer for interpreting and executing instructions. Command generation circuit 1303 may also generate row address strobe 1323 and column address strobe 1324 to provide control of SDRAM 108.

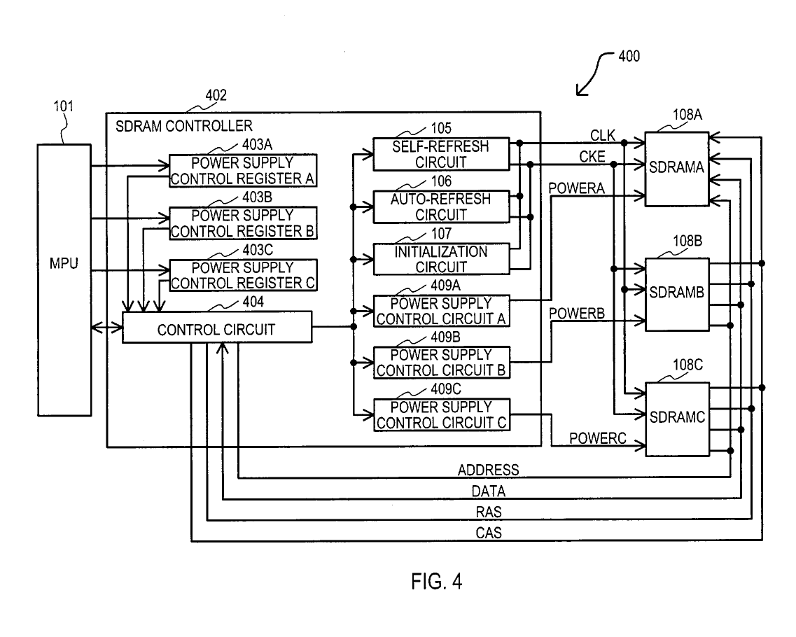

Referring now to FIG. 4, a system including a SDRAM controller according to an embodiment is set forth and given the general reference character 400. System 400 may include similar constituents as system 100 and such constituents may be referred to by the same reference character.

System 400 may include a MPU 101, a SDRAM controller 402, SDRAMs (108A to 108C), and other peripheral circuits (not shown in FIG. 4). System 400 may be included in a portable information device, or the like, to perform processing.

SDRAM controller 402 may control access (reading or writing) of data, or the like, and refresh operations in SDRAMs (108A to 108C). SDRAM controller 402 may receive requests from MPU 101 and may provide a clock signal CLK, a clock enable signal CKE, an address ADDRESS, a row address signal RAS, and a column address signal RAS to SDRAMs (108A to 108C). SDRAM controller 402 may also provide a power supply (POWERA to POWERC) to SDRAMs (108A to 108C), respectively. Other control signals (not shown) may also be provided to SDRAMs (108A to 108C) from SDRAM controller 402. SDRAM controller 402 may also receive or provide data DATA from/to SDRAMs (108A to 108C).

SDRAM controller 402 may include power supply control registers (403A to 403C), a control circuit 404, a self-refresh circuit 105, an auto-refresh circuit 106, an initialization circuit 107, and power supply control circuits (409A to 409C).

System 400 may differ from system 100 of FIG. 1 in that SDRAM controller 402 may include a plurality of power supply control registers (403A to 403B) and a plurality of power supply control circuits (409A to 409C). The plurality of power supply control registers (403A to 403B) and plurality of power supply control circuits (409A to 409C) may provide power supply (POWERA to POWERC) control to a plurality of SDRAMs (108A to 108C), respectively. Power supply control circuit 409A and power supply control register 403A may provide control of power supply POWERA of SDRAM 108A. Power supply control circuit 409B and power supply control register 403B may provide control of power supply POWERB of SDRAM 108B. Power supply control circuit 409C and power supply control register 403C may provide control of power supply POWERC of SDRAM 108C.

Power supply control registers (403A to 403C) may receive a power supply setting request from MPU 101 and provide power supply control register states to a control circuit 404. Control circuit 404 may receive a request from MPU 101 and may provide control signals to self-refresh circuit 105, auto-refresh circuit 106, initialization circuit 107, and power supply control circuits (409A to 409C). Control circuit 404 may also provide row address strobe signal RAS and column address strobe signal CAS to SDRAMs (108A and 108C) and may provide or receive data DATA to or from SDRAMs (108A and 108C). Self-refresh circuit 105, auto-refresh circuit 106, and initialization circuit 107 may provide a clock signal CLK and a clock enable signal CKE to SDRAMs (108A and 108C).

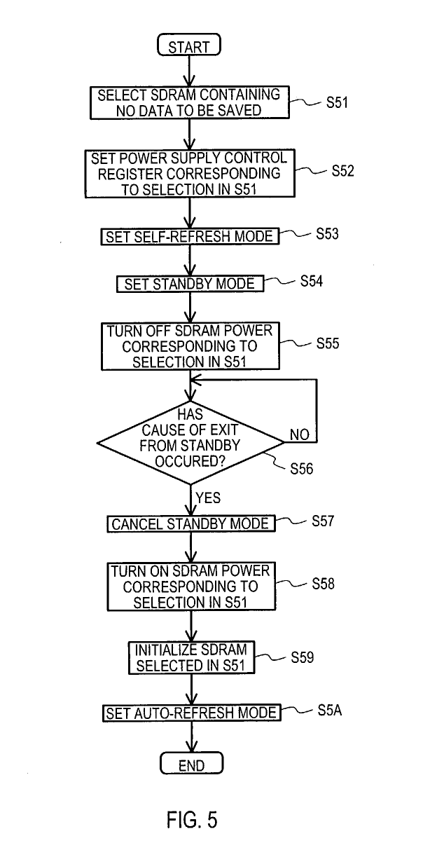

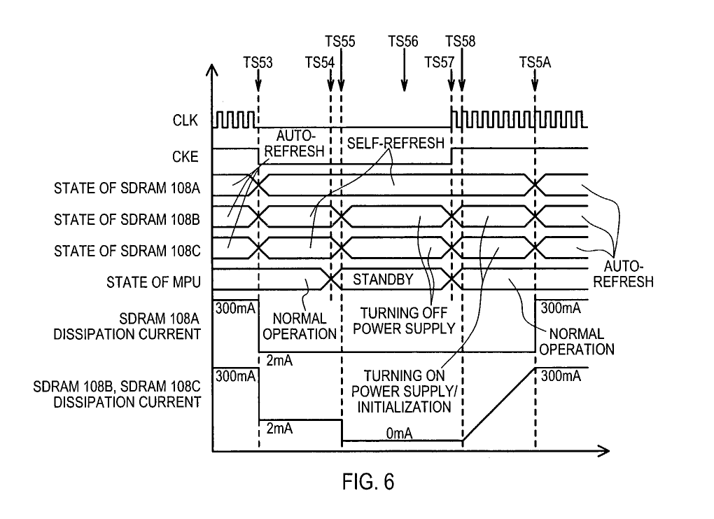

The operation of SDRAM controller 402 when system 400 transitions from a normal state to a standby state and transitions from a standby state to a normal state will now be described with reference to a flowchart of FIG. 5 and a timing diagram of FIG. 6 in conjunction with FIG. 4.

FIG. 5 is a flowchart showing operations for changing system 400 from a normal state to a standby state and from the standby state to a normal state according to an embodiment. FIG. 6 is a timing diagram showing transitions of system 400 between a normal state and a standby state according to an embodiment.

Referring now to FIGS. 5 and 6 in conjunction with FIG. 4, first, a request for transitioning of system 400 from a normal state to a standby state may be made. At this time, system 400 may make a determination as to whether data stored in each of SDRAMs (108A to 108C) is necessary or not necessary (step S51 in FIG. 5). In this example, it is assumed that it is necessary to save data stored in SDRAM 108A while data stored in SDRAMs (108B and 108C) may not be necessary.

In this case, MPU 101 may direct SDRAM controller 402 to store a low level in power supply control register 403A and a high level in powers supply control registers (403B and 403C) as indicated in step S52.

Subsequently, at time TS53 (FIG. 6), MPU 101 may issue a request to put SDRAMs (108A to 108C) into a self-refresh mode. In response to this request, SDRAM controller 402 may set clock enable signal CKE to a low level and disable clock signal CLK (stop oscillations). In this way, SDRAMs (108A to 108C) may transition to a self-refresh mode (step S53 in FIG. 5).

Then, at time TS54 (FIG. 6), MPU 101 may transition to a standby state and system 400 may enter a standby state (step S54). At time TS55 (FIG. 6), after SDRAMs (108A to 108C) have entered a self-refresh state, power supply control circuits (409B and 409C) may turn off power supplies (POWERB and POWERC) to SDRAMs (108B and 108C), respectively (step S55 in FIG. 5).

In this way, system 400 may transition to a standby state and overall power consumption may be reduced. Because power supply POWERA to SDRAM 108A is not turned off, SDRAM 108A may continue to hold the data stored therein in a self-refresh mode. In this way, the data in SDRAM 108A may be prevented from being lost.

System 400 may be maintained in a standby state (step S56 in FIG. 5 and time TS56 in FIG. 6) until an event, such as a key input, an external interrupt, or the like, occurs to cause an exit from the standby state.

When an event occurs to cause an exit from the standby state (time TS57 of FIG. 6), MPU 101 may transition from a standby state to a normal state (step S57 of FIG. 5) and may first provide a request to SDRAM controller 102 to turn on power supplies (POWERB and POWERC) of SDRAMs (108B and 108C), respectively (setting power supply control registers (403B and 403C) to store a logic low level).

SDRAM controller 402 may receive the request from MPU 101, and power supply control circuits (409B and 409C) may initiate turning on of power supplies (POWERB and POWERC), respectively (time TS58 in FIG. 6 and step S58 of FIG. 5). After power supplies (POWERB and POWERC) have been turned on sufficient to allow operation of SDRAMs (108B and 108C), SDRAM controller 402 may set clock enable signal CKE to a high level to enable the operation of clock signal CLK (clock signal CLK may begin to oscillate). Subsequently, SDRAM controller 402 may activate initialization circuit 107 to initialize SDRAMs (108B and 108C) (step S59 of FIG. 5).

After the completion of initialization, SDRAM controller 402 may activate auto-refresh circuit 106 to change over SDRAMs (108A to 108C) to a normal state (step S5A of FIG. 5). In this way, system 400 may complete a transition to a normal state.

In the embodiment of FIG. 4, a turn-on/off of a power supply (POWERA to POWERC) may be selected with respect to each SDRAM (108A to 108C) in a standby state. In this way, the operation for reducing power consumption may be performed with flexibility in accordance with data that may need to be saved.

It should be noted that although system 400 includes three SDRAMs (108A to 108C). The number of SDRAMs may be N, where N may be any integer greater than or equal to 1.

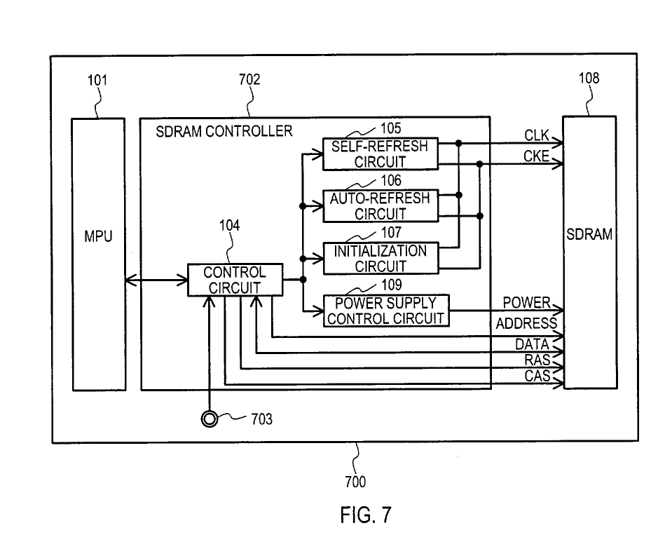

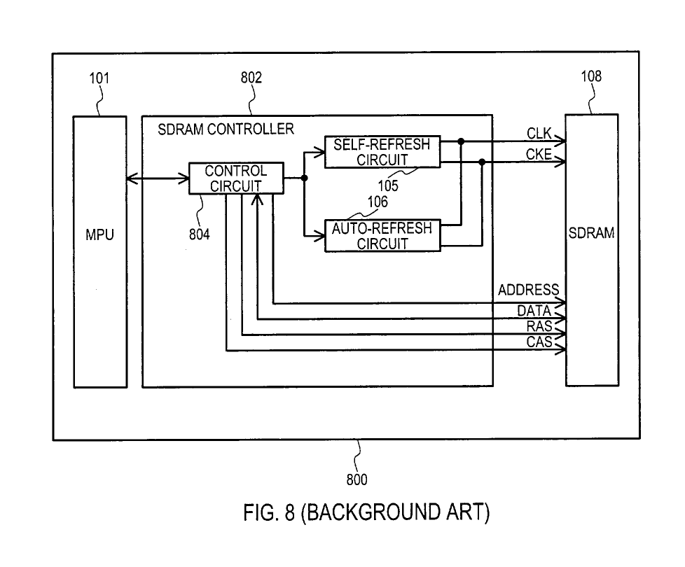

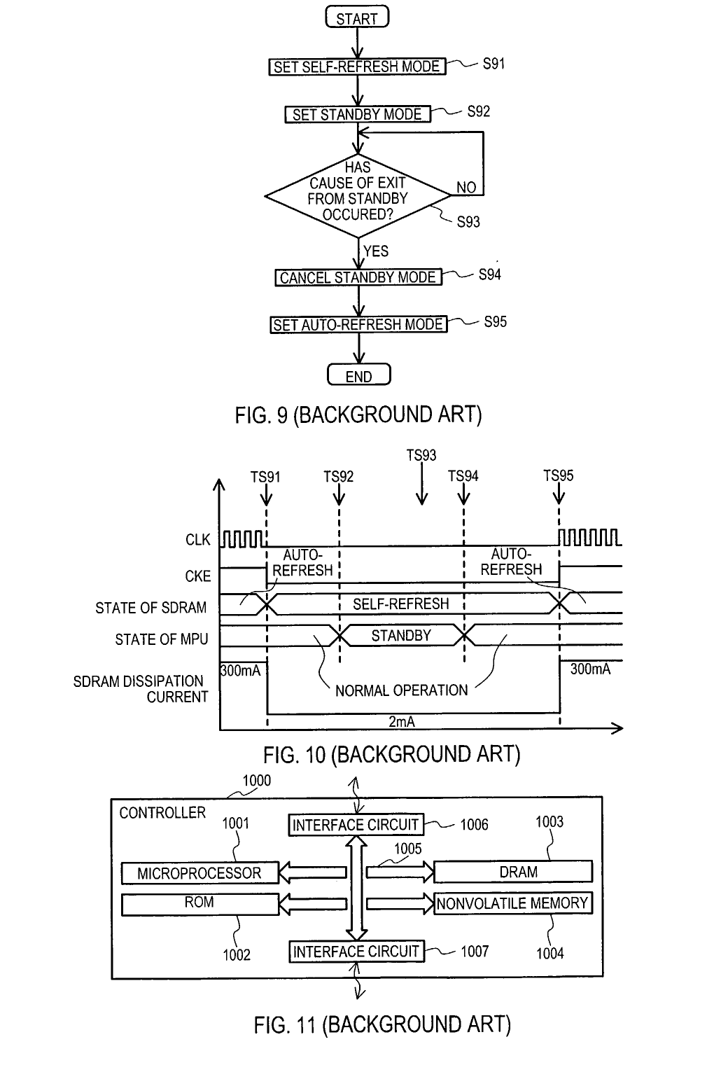

Referring now to FIG. 7, a system including a SDRAM controller according to an embodiment is set forth and given the general reference character 700. System 700 may include similar constituents as system 100 and such constituents may be referred to by the same reference character.

System 700 may include a MPU 101, a SDRAM controller 702, SDRAM 108, and other peripheral circuits (not shown in FIG. 7). System 700 may be included in a portable information device, or the like, to perform processing.

SDRAM controller 702 may control access (reading or writing) of data, or the like, and refresh operations in SDRAM 108. SDRAM controller 702 may receive requests from MPU 101 and may provide a clock signal CLK, a clock enable signal CKE, a power supply POWER, an address ADDRESS, a row address signal strobe RAS, and a column address strobe signal CAS to SDRAM 108. Other control signals (not shown) may also be provided to SDRAM 108 from SDRAM controller 702. SDRAM controller 702 may also receive or provide data DATA from/to SDRAM 108.

In the arrangement of FIG. 7, MPU 101 may perform overall control of system 700. When data stored in SDRAM 108 is to be read or when data is to be written to SDRAM 108, MPU 101 may provide a request to SDRAM controller 702. SDRAM controller 702 may recognize the request from MPU 101 and may access the SDRAM 108 accordingly. SDRAM controller 702 may operate in a similar manner to other requests to perform direct control of SDRAM 108.

SDRAM controller 702 may include a control circuit 104, a self-refresh circuit 105, an auto-refresh circuit 106, an initialization circuit 107, and a power supply control circuit 109 similarly to SDRAM controller 102 of system 100 in FIG. 1. However, SDRAM controller 702 of system 700 may include a power supply control signal terminal 703. Power supply control signal terminal 703 may receive an externally applied power supply control signal.

In system 700, MPU 101 may provide a power supply setting request and provide a power supply control register state to a control circuit 104. However, in system 700, an instruction including a power supply control signal may be provided externally other than from MPU 101 to perform power supply switching in accordance with whether data stored in SDRAM 108 is necessary or unnecessary.

Otherwise, system 700 may operate in substantially the same manner as system 100 of FIG. 1 by providing a power supply control signal to a power supply control signal terminal 703 instead of including a power supply control register 103.

In system 700, only one SDRAM 108 is illustrated, however, it may also be possible to have a plurality of SDRAMs 108 and SDRAM controller 700 may include a plurality of power supply control signal terminals 703 for receiving a plurality of power supply control signals. In this way, each of a plurality of SDRAMs may have power supplies controlled separately in a standby state in a similar manner as system 400 of FIG. 4.

Another embodiment will not be described. Referring once again to the flowchart of FIG. 2, turn-on of a power supply to an SDRAM is described in step S2D. In the description of system 100 of FIG. 1, it is explained that MPU 101 may issue a request to turn on a power supply to an SDRAM in step S2D.

However, to ensure compatibility with a conventional SDRAM controller, control of a power supply may be performed without issuing the request for turning on a power supply to an SDRAM 108 from MPU 101. This may be performed in such a manner that a power supply to a SDRAM 108 may be turned on, if a changeover to a normal mode is effected or initialization circuit 107 operates.

In such an embodiment, even though MPU 101 may not perform such control as to turn on or off a power supply to SDRAM 108, an SDRAM controller may decide to turn off or keep on a power supply to an SDRAM 108. This may be performed, for example, in accordance with a flag indicating whether or not data is necessary or unnecessary. In this way, power consumption may be reduced without performing additional processing by, for example, a MPU 101.

As described above, an SDRAM controller according to the embodiments may provide control so that power supply to an SDRAM may be turned on/off when the system is in a standby state. In this way, power consumption may be reduced.

Further, the power supply to an SDRAM storing data necessary for the system may not be turned off. In this way, a time period required for a transition from a standby state to a normal state may not be increased.

It is understood that the embodiments described above are exemplary and the present invention should not be limited to those embodiments. Specific structures should not be limited to the described embodiments.

For example, although the embodiments were discussed with respect to an SDRAM controller, a system with other volatile semiconductor memory devices (Static RAM (SRAM), Synchronous SRAM, DRAM, as just a few examples) may benefit from the invention.

Thus, while the various particular embodiments set forth herein have been described in detail, the present invention could be subject to various changes, substitutions, and alterations without departing from the spirit and scope of the invention. Accordingly, the present invention is intended to be limited only as defined by the appended claims.

What is claimed is:

1. A synchronous dynamic random access memory (SDRAM) controller which controls operations of a SDRAM including reading and writing according to instructions received from a microprocessor unit (MPU), comprising:
a power supply designation circuit designating maintaining or turning off of a power supply provided to the SDRAM when the SDRAM is in a low power consumption state in accordance with whether data stored in the SDRAM is necessary or unnecessary;
a control circuit controlling the operation of circuits included in the SDRAM controller according to instructions received from the MPU; and
a power supply control circuit controlling turning off/maintaining the power supply in accordance with a power supply logic signal provided by the power supply designation circuit.

2. The SDRAM controller according to claim 1, wherein:
the power supply control circuit turns off the power supply to the SDRAM in response to the power supply logic signal being a power supply turn off logic level and an instruction from the MPU to effect a transition to the low power consumption state and the power supply control circuit turns on the power supply to the SDRAM in response to an instruction from the MPU to effect a transition to a normal state.

3. The SDRAM controller according to claim 1, wherein:
the power supply status designation circuit includes a latch circuit having a power supply status indicator loaded into in response to a write signal.

4. The SDRAM controller according to claim 1, wherein:
the power supply status designation circuit includes a power supply status designation terminal coupled to receive the power supply logic signal provided from external to the SDRAM controller.

5. The SDRAM controller according to claim 1, wherein:
the power supply control circuit turns off the power supply to the SDRAM when the SDRAM is in a self-refresh mode and the data stored in the SDRAM is unnecessary.

6. The SDRAM controller according to claim 1, wherein:
the power supply status designation circuit is coupled to receive an address from an address bus and a data signal from a data bus and stores the data signal as the power supply logic signal in response to a write signal when the register address has a predetermined address value.

7. The SDRAM controller according to claim 1, wherein:
the control circuit includes
an address generation circuit coupled to receive an address and determine whether the address is for the SDRAM or for the SDRAM controller;
a command generation circuit coupled to receive instructions from the MPU and provide control signals controlling the operation of at least one circuit in the control circuit; and
a control register coupled to receive data from a data bus and setting an operation of the SDRAM controller.

8. The SDRAM controller according to claim 7, wherein:
the control circuit further includes
a data latch coupled between the MPU and the SDRAM and providing handshake for data timing between the MPU and the SDRAM; and
a latch circuit coupled to receive a row address and a column address from the address generation circuit and provide a handshake for address timing to SDRAM.

9. The SDRAM controller according to claim 7, wherein:
the command generation circuit includes a timer for setting timing and a decoder and sequencer for executing instructions.

10. A method of controlling a first synchronous dynamic random access memory (SDRAM) with a SDRAM controller in a system, comprising the steps of:
receiving a request to transition the system from a normal state to a standby state;
determining whether a first power supply provided to the first SDRAM is to be turned off or kept on in accordance with whether data stored in the first SDRAM is necessary or unnecessary; and
turning off the first power supply provided to the first SDRAM if the step of determining determines that the data stored in the first SDRAM is unnecessary.

11. The method according to claim 10, further including the step of:
providing a first power supply status indication to the SDRAM controller after determining whether the first power supply provided to the first SDRAM is to be turned off or kept on.

12. The method according to claim 10, further including the step of:
setting the first SDRAM in a low power consumption state before the step of turning off the first power supply.

13. The method according to claim 10, further including the steps of:
receiving a request to transition the system from the standby state to the normal state; and
turning on the first power supply provided to the first SDRAM if the step of determining determined that the data stored in the first SDRAM was unnecessary.

14. The method according to claim 13, further including the steps of:
initializing the first SDRAM after the step of turning on the first power supply.

15. The method according to claim 10 wherein the system further includes a second SDRAM, further including the steps of:
determining whether a second power supply provided to the second SDRAM is to be turned off or kept on in accordance with whether data stored in the second SDRAM is necessary or unnecessary; and
turning off the second power supply provided to the second SDRAM if the step of determining determines that the data stored in the second SDRAM is unnecessary.

16. The method according to claim 15, further including the steps of:
providing a first power supply status indication to the SDRAM controller after determining whether the first power supply provided to the first SDRAM is to be turned off or kept on; and
providing a second power supply status indication to the SDRAM controller after determining whether the second power supply provided to the second SDRAM is to be turned off or kept on.

17. The method according to claim 15, further including the steps of:
setting the first SDRAM in a low power consumption state before the step of turning off the first power supply; and
setting the second SDRAM in the low power consumption state before the step of turning off the second power supply.

18. The method according to claim 15, further including the steps of:
receiving a request to transition the system from the standby state to the normal state;
turning on the first power supply provided to the first SDRAM if the step of determining determined the data stored in the first SDRAM was unnecessary; and
turning on the second power supply provided to the second SDRAM if the step of determining determined the data stored in the second SDRAM was unnecessary.

19. The method according to claim 18, further including the steps of:
initializing the first SDRAM after the step of turning on the first power supply; and
initializing the second SDRAM after the step of turning on the second power supply.

20. The method according to claim 10, further including the step of:
setting the first SDRAM in a self-refresh mode before the step of turning off the first power supply.
